(19) United States
(12) Patent Application Publication
(10) Pub. No.: US 2005/0054506 A1
(43) Pub. Date: Mar. 10, 2005

(54) Microbial concentration system

(76) Inventor: Bruce J. Bradley, Jerome, ID (US)

Correspondence Address: DYKAS, SHAVER & NIPPER, LLP, P.O. BOX 877, 802 WEST BANNOCK STREET, SUITE 405, BOISE, ID, 83701, US

(21) Appl. No.: 10/903,895

(22) Filed: Jul. 30, 2004

Related U.S. Application Data
(60) Provisional application No. 60/491,578, filed on Jul. 30, 2003.

(51) Int. Cl. B04B 7/08

(52) U.S. Cl. 494/31

(57) ABSTRACT

A centrifuge separation chamber of particular use for separating microbes. The chamber has an upwardly flared conical shape, and a sample collecting groove at its widest point. Sample is collected in the sample groove as the chamber spins. When slowed to a stop, the supernatant sinks to the bottom of the chamber, leaving the sample in the sample groove where it can be easily accessed.

### PRIORITY

This application claims the priority date of the provisional application entitled HIGH EFFICIENCY LIQUID MICROBIAL CONCENTRATION SYSTEM filed by Bruce J. Bradley on Jul. 30, 2003 with application Ser. No. 60/491,578.

### BACKGROUND OF THE INVENTION

1. Field of the Invention

The present invention relates generally to the field of liquid centrifuge separation chambers. More particularly, the present invention provides a high efficiency liquid microbial concentration system using a collection groove positioned at the point of peak relative centrifugal force.

2. Background Information

Centrifuge separation chambers are used to sample microbes for various applications. In many cases, the effectiveness of the microbial recovery depends on the sampling procedures and the concentrations available. For example, rotary bucket centrifuges are commonly used in laboratories for routine separation of small particles, such as bacteria, from the suspension liquid and varying densities of sediments and other materials. Present centrifuge systems and centrifuge separation chambers do not provide sufficient sampling capabilities, detection sensitivity, speed or reliability necessary for many applications. For example, sampling that occurs for chemical and biological defense must be carried out with utmost efficiency in order to save lives and keep civilians and professional personnel out of harms way.

The need for improved and more rapid detection efficiency of food and water-borne microbial pathogens has emphasized the need for concentration of diluted environmental samples in order to locate and identify low levels of widely dispersed or diluted microbial pathogens. Additionally, continuing problems in the food processing of a number of different kinds of foods, especially meat, requires rapid collection, analysis and detection of microbial contaminants of food. As a result, there is a need for a rapid microbial concentration system that allows samples to be quickly concentrated for testing and analysis purposes. Such systems need to be both reliable and fast in providing microbial sample results.

Accordingly, it is an object of the present invention to provide a centrifuge separation chamber that facilitates microbial concentration. Another object of the present invention is to provide a centrifuge separation chamber that facilitates pathogen and microbe collection at relatively low RPM's. Another object of the present invention is to provide a centrifuge separation chamber for partitioning large, dense particles from a suspension and simultaneously concentrating microorganisms or other small, less dense particles from liquid suspensions for easy sampling using a rotary-axis, cyclonic centrifuge separation chamber. An additional object of the present invention is to provide a sampling system that combines a surface sampling unit with a centrifuge separation chamber in which the sample is collected for rapid concentration and detection.

Additional objects, advantages and novel features of the invention will be set forth in part in the description which follows and in part will become apparent to those skilled in the art upon examination of the following or may be learned by practice of the invention. The objects and advantages of the invention may be realized and attained by means of the instrumentalities and combinations particularly pointed out in the appended claims.

### SUMMARY OF THE INVENTION

The purpose of the foregoing Abstract is to enable the United States Patent and Trademark Office and the public generally, and especially the scientists, engineers, and practitioners in the art who are not familiar with patent or legal terms or phraseology, to determine quickly from a cursory inspection, the nature and essence of the technical disclosure of the application. The Abstract is neither intended to define the invention of the application, which is measured by the claims, nor is it intended to be limiting as to the scope of the invention in any way.

One version of the invention is a centrifuge separation chamber. The separation chamber includes a chamber base, to which is attached a frustoconical or cone shaped first chamber sidewall section. The chamber sidewall can be thought of as having a bottom edge and a top edge, with the bottom edge attached to the chamber base. The top edge extends upward and flares outward. Thus, the sidewall is generally frustoconical in shape and smaller at the bottom than at the top. At the top edge of the chamber sidewall is located a sample groove. The sample groove may include a sample groove lip, and adjacent and attached to the sample groove lip is a sample reservoir. A sample reservoir is positioned at a slightly lower level than the lip, so that when the sample reservoir is filled with a substance, it is held in place by the lip and does not flow down the interior of the chamber. Another variation of the device does not have the sample groove lip and sample reservoir.

Attached to the sample reservoir is a chamber roof, which extends in a frustoconical shape upwards and towards the center of the separation chamber, and joins a central chamber opening. The central chamber opening is typically a sealable passage through which sample can be introduced into the separation chamber. The centrifuge separation chamber is radially symmetrical and has a radial axis that runs from the middle of the central chamber opening through the middle of the chamber base.

The centrifuge separation chamber is configured to spin around an axis of rotation, which is parallel with the radial axis of the separation chamber. When the separation chamber is spinning, heavier particles in the sample move toward the exterior of the chamber sidewall, and are collected in the sample groove. Such particles pass over the lip of the sample groove and collect in the sample reservoir. When the spinning of the centrifuge slows and stops, liquid supernatant in the sample moves towards the chamber base and the heavier particles in the sample remain trapped in the sample reservoir. Heavy particles can mean anything that is heavier than the supernatant liquid including microbes, cellular organelles, undissolved particles, dust, etc.

The centrifuge separation chamber of the invention can be configured to operate when the axis of rotation is the same as the radial axis of the centrifuge separation chamber. It can also be configured to operate when the axis of rotation is parallel, but different than the radial axis of the centrifuge separation chamber.

The centrifuge separation chamber can be configured so that the chamber base is convex on the outside, and thus concave on the inside surface. Alternatively, the separation chamber base can be configured to be generally flat. In either configuration, the centrifuge base may include a drain orifice for removing the supernatant liquid from the chamber.

Another version of the centrifuge separation chamber can include a second frustoconical sidewall section, in which the sidewall taper is opposite to that of the first frustoconical sidewall section. The second sidewall section, in this version, is attached to the chamber base and is wider at the chamber base and tapers inwardly. At its most extreme inward position, the second sidewall section connects with the first frustoconical sidewall section, which flares outward and upward. This provides two collection basins in the separation chamber. The lower separation chamber, located inside the second frustoconical chamber sidewall, is available for collection and concentration of larger particles of debris in the sample. These larger particles would tend to settle to the bottom of the separation chamber, and this settling could be utilized to gather such debris in the bottom of the chamber. Then when spinning began, the heavier particles would remain trapped in the lower concentration chamber, while the supernatant and suspended smaller particles would move into the upper collection reservoir. As spinning continues, the suspended small particles would migrate toward the first frustoconical sidewall section, and collect in the collection groove after passing over the collection groove lip, and into the collection reservoir.

In order to facilitate debris collection, the double tapered centrifuge separation chamber described above can be spun at an angle to the axis of rotation for part or all of the centrifuge cycle.

In some situations, the centrifuge collection chamber of the invention could be modified, while still utilizing the same sidewall design and collection concept. This modification would occur for samples that are arranged radially around an axis of rotation. One version of the centrifuge separation chamber would operate when it is centered on the axis of rotation. In that case the separation chamber would be radially symmetrical, and the separation chamber would extend 360 degrees around the axis of rotation. This would also be the radial axis of the separation chamber. However, another mode of operation for using the centrifuge separation chamber would be to arrange a number of separation chambers radially around an axis of rotation. In such a situation, the centrifuge separation chambers could be radially symmetrical, as described above. However, only the side of the separation chamber that faces away from the axis of rotation would be needed for concentration of samples. For this reason an arc of the 360 degrees of the radially symmetrical separation chamber could be utilized, attached to two or more generally flat sidewalls. This shape would allow the centrifuge separation chambers to be arranged like slices of pie for efficient placement around an axis of rotation. As the particles moved through the sample and contacted the frustoconical section of the sidewall away from the axis of rotation, the same collection principle would apply in which microbes are collected in the sample reservoir. Such a separation chamber could be made with two, three or more flat walled sidewalls, so that they fit together in a generally pie shaped and radial configuration.

In the configuration of the centrifuge vessel, which is designed for radial placement around an axis of rotation, the frustoconical sidewall of the separation chambers could include a single frustoconical section or could again include a double frustoconical section, which provides for two concentration areas. Once again, this would be for first separating and concentrating heavy particles of debris from the lighter particles, which are suspended in the sample, and would not settle to the bottom of the chamber.

In either the radial or non-radial configured chamber described above, the collection groove can drain to a central point to make the collection of samples more efficient.

The invention also includes a sampling and concentration system of which this centrifuge separation chamber, with all its variations, is a part. This sampling system includes the various configurations of the centrifuge sampling chamber described above, combined with a vacuum based sample collection unit, which is configured to pick up a liquid suspended sample and deliver it into the centrifuge separation chamber for concentration and detection.

Still other objects and advantages of the present invention will become readily apparent to those skilled in this art from the following detailed description wherein I have shown and described only the preferred embodiment of the invention, simply by way of illustration of the best mode contemplated by carrying out my invention. As will be realized, the invention is capable of modification in various obvious respects all without departing from the invention. Accordingly, the drawings and description of the preferred embodiment are to be regarded as illustrative in nature, and not as restrictive in nature.

### BRIEF DESCRIPTION OF THE DRAWINGS

FIG. 1 is a cross sectional view of one version of the centrifuge chamber.

FIG. 2 is a version of the centrifuge chamber with a debris trap.

FIG. 3A is a few of a number of centrifuge chambers of the invention positioned for centrifugation.

FIG. 3B shows partial frustocone chambers.

FIG. 4A is a cross sectional view of one version of the centrifuge chamber of the invention.

FIG. 4B is a top view of one version of the centrifuge chamber.

FIG. 4C is a top view of another version of the centrifuge chamber.

FIG. 5 is a cross sectional view of the centrifuge chamber attached to a vacuum collection system.

FIG. 6 is a cut away view of the spherical bottom version of this centrifuge chamber.

FIG. 7 is a perspective exploded view of the spherical bottom version.

FIG. 8 is a cut away of the exploded view of the reverse taper in debris collection section.

FIG. 9 is a reverse taper in debris collection section.

FIG. 10 is an exploded view of reverse taper in debris collection section.

FIG. 11A is a side cross sectional view of a version of the device.

FIG. 11B is a top view of a version of the device.

FIG. 12 is a diagram showing a non-radial collection point for a separation chamber

FIG. 13 shows the base angle of an alternate collection groove for a non-radial collection point.

FIG. 14. shows a version of the device with a non-radial collection point.

### DESCRIPTION OF THE PREFERRED EMBODIMENTS

While the invention is susceptible to various modifications and alternative constructions, certain illustrated embodiments thereof have been shown in the drawings and will be described below in detail. It should be understood, however, that there is no intention to limit the invention to the specific form disclosed, but, on the contrary, the invention is to cover all modifications, alternative constructions, and equivalents falling within the spirit and scope of the invention as defined in the claims.

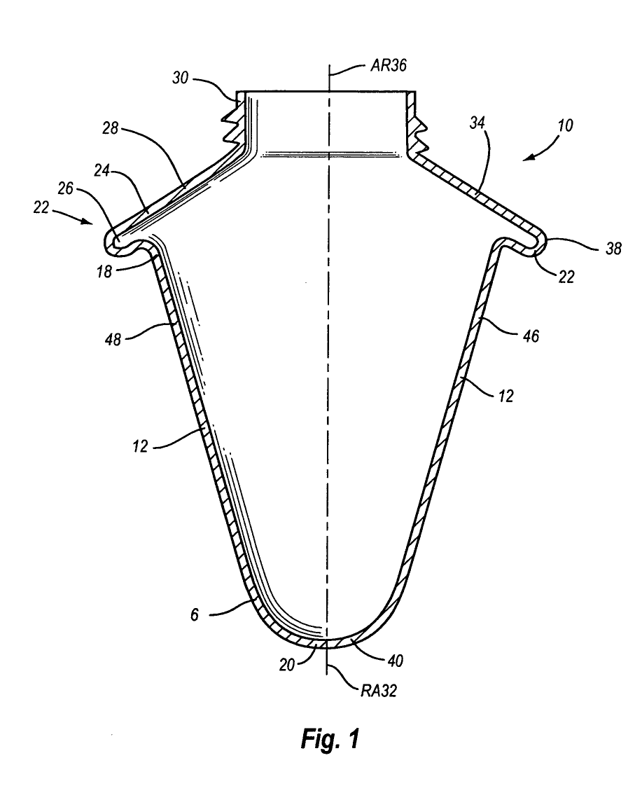

FIGS. 1-11B show several different preferred embodiments of the invention. FIG. 1 shows one preferred version of the collection vessel of the invention. FIG. 1 shows a centrifuge separation chamber 10 of the invention. It includes a first frustoconical chamber sidewall 12 attached to a chamber base 20. In this case, the chamber base 20 forms a convex base 40. Other versions of the device include a generally flat chamber base 20. The first frustoconical chamber sidewall 12 includes a bottom edge 16, which is connected to the chamber base 20. It also includes a top edge 18, which is attached to the sample groove 22. The sample groove 22 includes a sample groove lip 24 and a sample reservoir 26. Attached to the sample groove 22 is a chamber roof 28, which tapers inward to the central chamber opening 30. This is shown as being closeable by threads, and could also be closeable by snap fit or other closure mechanisms. The centrifuge separation chamber 10 is designed so that it can be spun around an axis of rotation (AR). In one configuration of the device, the axis of rotation is the same as the radial axis (RA) of the centrifuge separation chamber 10. In that case, an individual separation chamber would be spun around the radial axis and the axis of rotation in order to separate heavier particles within a sample from the lighter particles. Heavier particles could include anything that is heavier than the solution in which they are suspended, but is particularly directed at microbes. Other small particles could also be concentrated and sampled such as cellular organisms, cell parts such as mitochondria or nuclei, or other debris such as silt or suspended organic particles.

In the preferred embodiment, the sample groove 22 is located at the point of peak relative centrifugal force 38. In most cases, this is merely the point that is the furthest away from the axis of rotation. Shown at 46 and 48 is the position of the sample while the centrifuge separation chamber is spinning. During that time, it is spun as far away from the axis of rotation as possible. While it is spinning, particles 34, which are suspended in the sample, migrate towards the first frustoconical chamber sidewall 12 and are collected in the sample groove 22.

The centrifuge separation chamber of the invention can be made of a number of types of materials, and a plastic with a very smooth wall is preferred. These materials can include Teflon, nylon, polyethylene, polypropylene, and other plastics that have a suitably smooth sidewall.

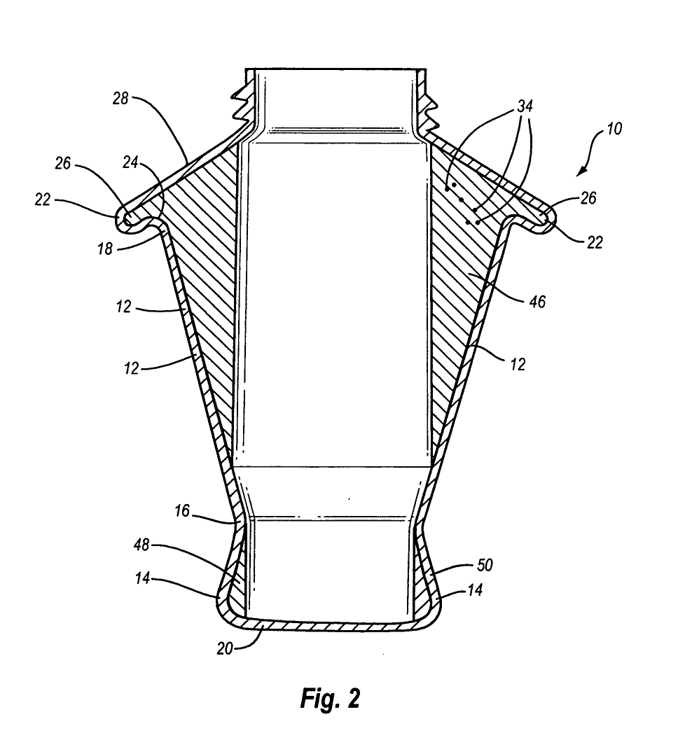

FIG. 2 is a similar view as FIG. 1 of a preferred embodiment of the centrifuge separation chamber 10 of the invention. It includes the same features as shown in FIG. 1, such as a first frustoconical chamber sidewall 12 with a top edge 18 and a bottom edge 16. This version includes a chamber base 20, which is generally flat bottomed. It also includes a sample groove 22 in which samples collect in a sample reservoir 26. Also shown are the sample levels during spinning 46 and 48. Additionally, this version of the separation chamber includes a second frustoconical chamber sidewall 14. As shown in FIG. 2, the second frustoconical chamber sidewall 14 forms a separate zone of concentration of sample. This second zone is used in the following way. When a sample is first placed in the separation chamber of the design shown in FIG. 2, it can be allowed to remain stationary for a period of time. During this settling time, larger particles can settle to the bottom of the chamber. This can include silt, cellular debris, organic debris or other things that are heavier than the solution and not truly suspended. Once spinning of the sample starts, these heavier particles remain in the second frustoconical chamber sidewall 14 and are trapped in a debris zone 50. The sample that is in the sample level 46 and 48 contains lighter particles and particles that are truly suspended either by Brownian motion or by virtue of their neutral buoyancy. Thus, the debris zone 50 helps to achieve a cleaner concentration of particles in the sample reservoir 26.

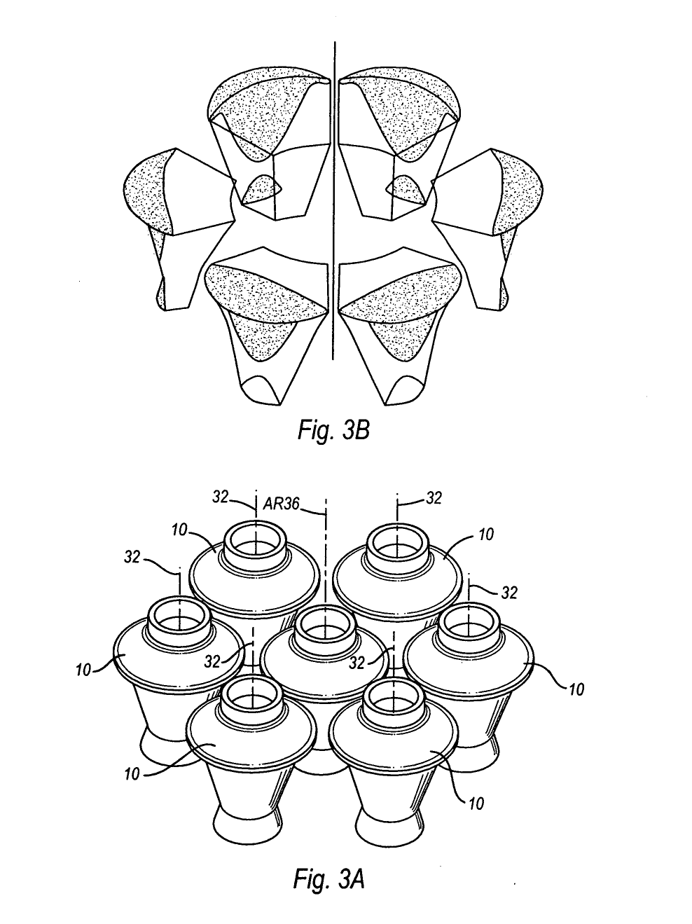

FIG. 3A shows a number of the devices from FIG. 2 arranged radially for centrifugation. The axis of rotation is indicated as AR and passes through the central separation chamber in this case. Other configurations could operate with separation chambers arranged radially around the axis of rotation without a separation chamber aligned with the axis of rotation. In the configuration shown in FIG. 3A, each of the separation chambers 10 has a radial axis 32, which is parallel with the axis of rotation 36. In this configuration, when the samples were centrifuged, the sample would flow to the portion of the chamber that is opposite to the axis of rotation. This would be the portion of the sidewall and the sample reservoir in the sidewall, which is furthest away from the axis of rotation. FIG. 3B shows the portions of the centrifuge separation chambers 10 in which sample would collect during spinning and which is opposite from the axis of rotation of the centrifugation assembly.

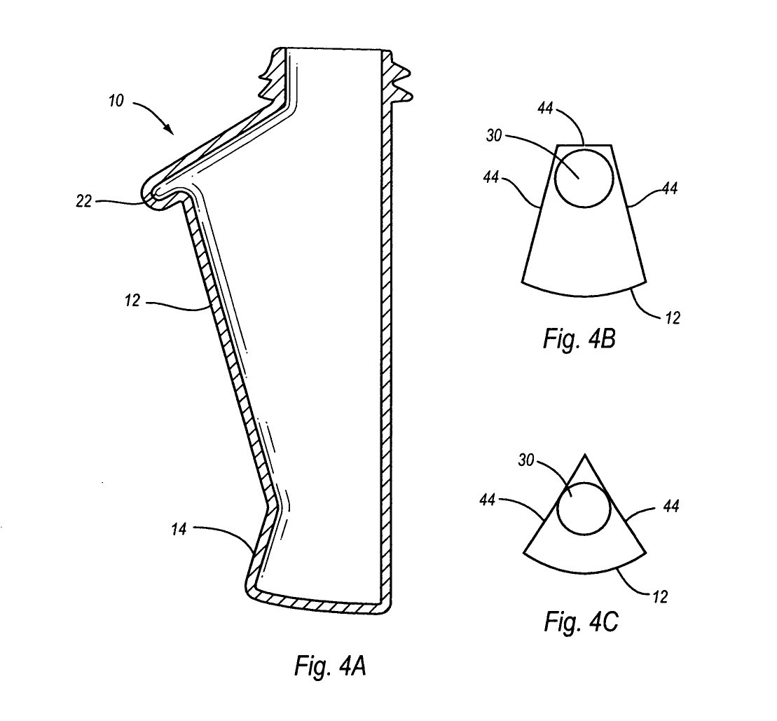

FIG. 4A shows an alternative form of the centrifuge separation chamber. This version of the separation chamber includes a first frustoconical chamber sidewall 12, and optionally a second frustoconical chamber sidewall 14. It also includes a number of generally flat sidewalls 44. FIGS. 4B and 4C show a top view of two embodiments of this version. These are arranged so that they may be placed side by side, radially around the axis of rotation in a centrifugation assembly. The axis of rotation of the centrifugation assembly would be opposite the first and second frustoconical chamber sidewalls 12 and 14.

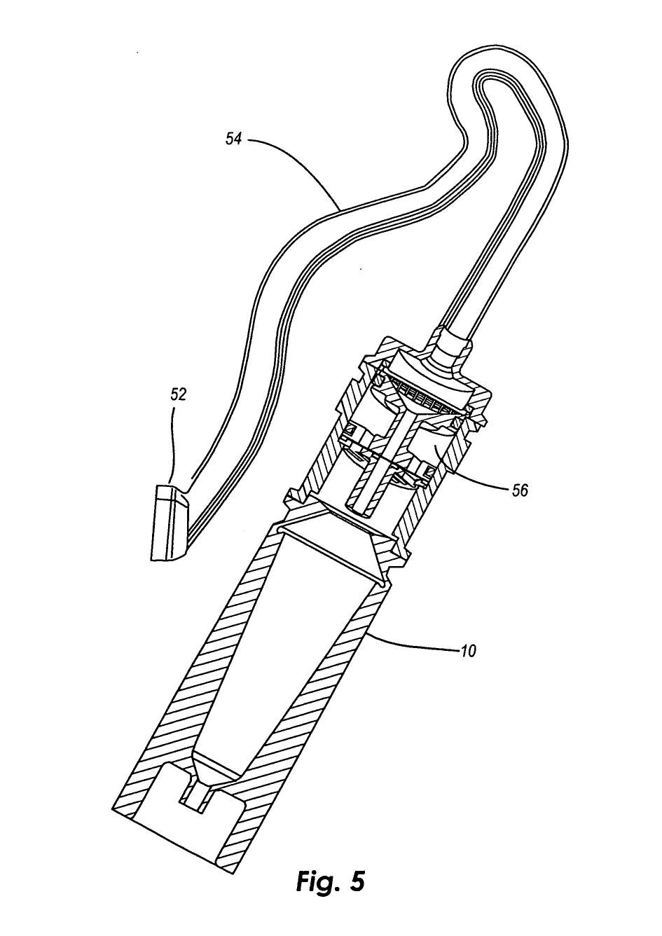

FIG. 5 shows another embodiment of the centrifuge separation chamber 10 as it is used with a vacuum operated collection head 52. A vacuum operated collection head 52 is connected to the centrifuge separation chamber 10 by a hose or conduit 54, which passes through a filtration unit 56. The filtration unit 56 is preferably identical or similar to the filtration unit described in U.S. Pat. Nos. 5,868,928 and 6,550,347, which are incorporated herein by reference. The two components together, the filtration unit 56 and the centrifuge separation chamber 10 thus forms a system for collecting, separating and concentrating microbes picked up by the vacuum operated collection head 52. The design of the filtration unit 56 allows a high flow of air, and collects and concentrates particles such as microbes for further analysis, confirmation, concentration and identification in the centrifuge separation chamber 10.

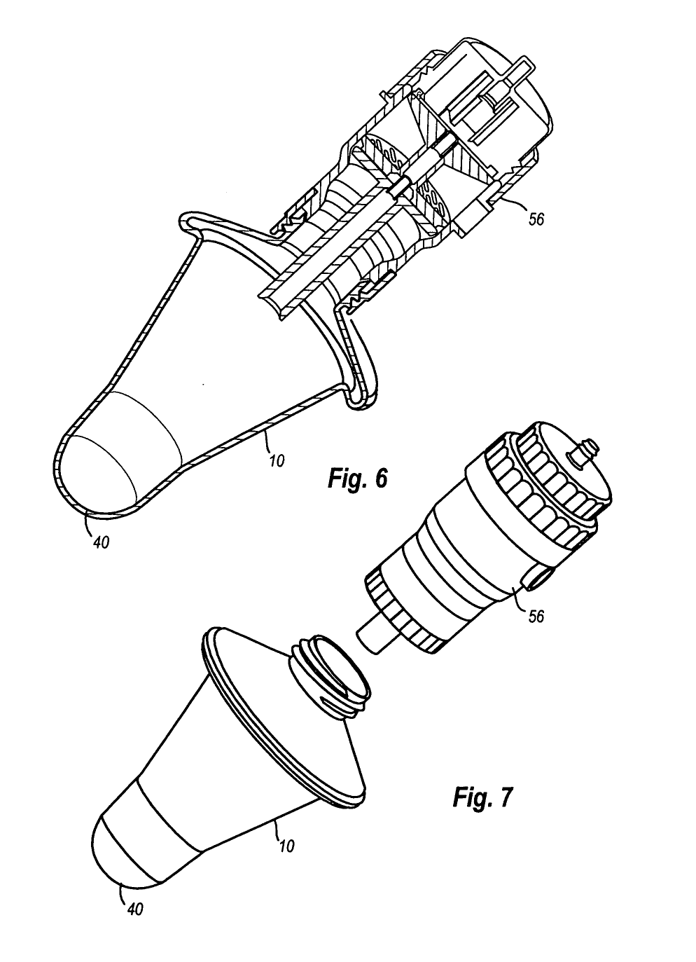

FIGS. 6 and 7 show a centrifuge separation chamber 10 with a convex base 40 as it attaches to a filtration unit 56. As described above, the two would work in conjunction to collect a sample for concentration by centrifugation.

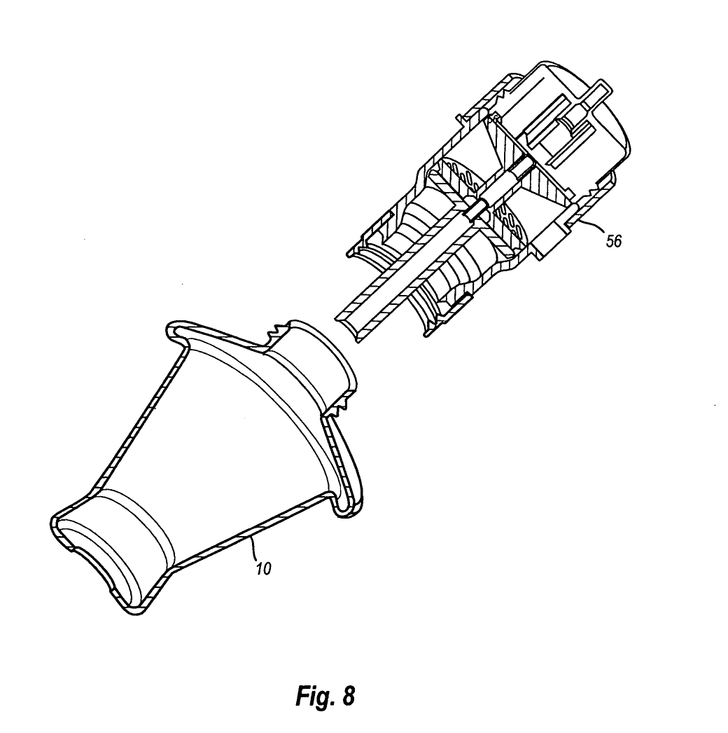

FIG. 8 shows a centrifuge separation chamber 10 attached to a filtration unit 56.

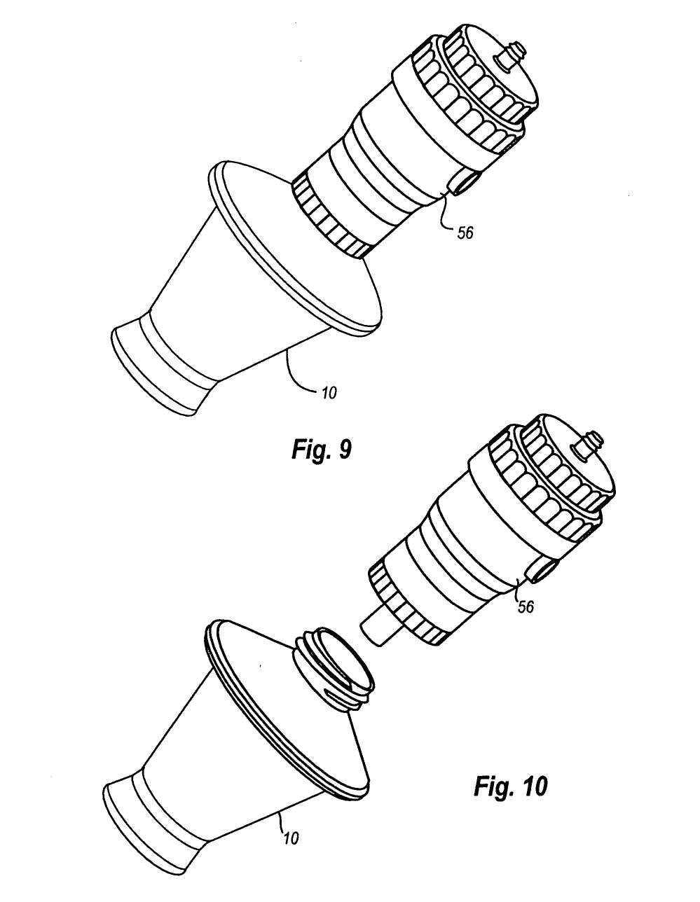

FIGS. 9 and 10 similarly show a centrifuge separation chamber 10 attached to a filtration unit 56.

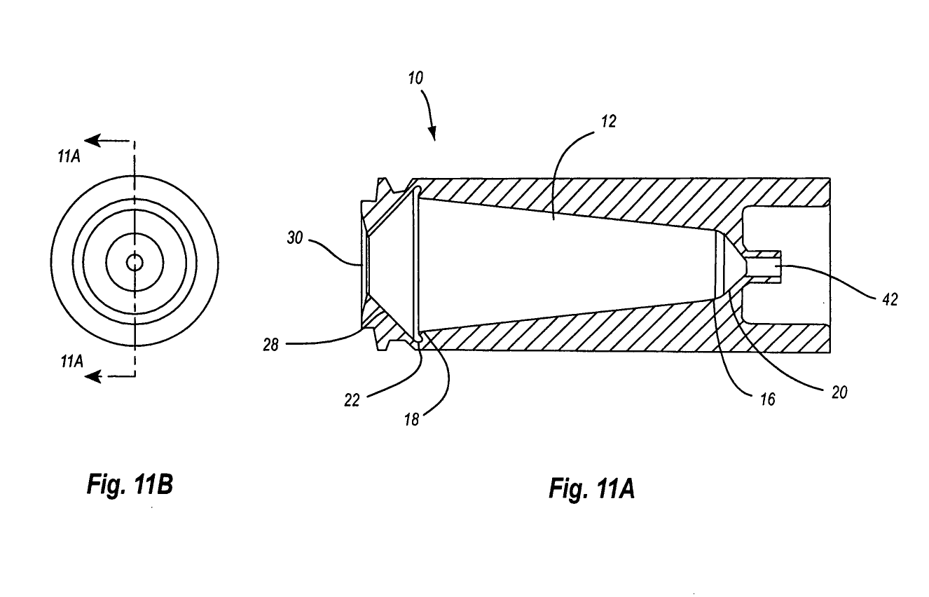

FIG. 11A shows additional detail of one version of a centrifuge separation chamber 10, which is attachable to the filtration unit 56. This unit includes the basic functional designs that have been discussed in other versions, including a first frustoconical chamber sidewall 12, a bottom edge 16, top edge 18, a chamber base 20, a sample groove 22, chamber roof 28, and a central chamber opening 30. It also includes a drain orifice 42. In this particular embodiment, the wall thickness is such that the outer diameter of the chamber is basically cylindrical, while the inner portion of the chamber is generally conical. In this case, the outer wall diameter is not critical to the functioning of the unit, but merely provides a better handgrip for manipulating the centrifuge separation chamber 10.

FIG. 11B is a top view of the centrifuge separation chamber 10 that is shown in FIG. 11A.

The present invention is a high efficiency liquid microbial concentration system. The system is generally embodied in the form of a centrifuge separation chamber 10. The centrifuge separation chamber 10 as herein defined is a collection receptacle used to concentrate collected bacteria and other collected materials by rotation of liquid within the centrifuge separation chamber 10 about its own longitudinal axis. The centrifuge separation chamber 10 walls are formed in the shape of a first frustoconical chamber sidewall 12. The bottommost portion of the first frustoconical chamber sidewall 12 is narrower than an upper portion of the walls. In one embodiment of the present invention, a chamber base 20 connected to the bottommost portion of the first frustoconical chamber sidewall 12 is rounded. In additional embodiments, the chamber base 18 comes to a point or may be flat. The upper portion of the first frustoconical chamber sidewall 12 transitions into a sample groove 22.

The centrifuge separation chamber 10 of the present invention is designed to safely rotate at velocities from 2,000 up to 5,000 to 10,000 revolutions per minute (RPM) for short periods to rapidly pull suspended pathogens and microbes into the sample groove 22 positioned at the point of peak relative centrifugal force (RCF) for microbes. The centrifuge separation chamber 10 reduces or eliminates the need for laboratory pre-enrichment work on a sample, a step that is often necessary to get proper microbial concentration. In one preferred embodiment, the centrifuge separation chamber 10 is a disposable cyclonic centrifuge, collection, transportation and lab processing chamber used to concentrate microbial pathogens without transferring potentially biohazardous materials between multiple pieces of labware in order to be processed.

In general, the centrifuge separation chamber 10 functions by allowing the liquid within the centrifuge separation chamber 10 to be rotated about its longitudinal axis at high angular velocities. As the centrifuge separation chamber 10 begins to rotate, microscopic particles within the sample are spun to the sample groove 22 and to edges of the first frustoconical chamber sidewall 12. As the chamber continues to spin, the smallest particles move to the point of highest RCF as a result of Stoke's law.

Since the sample groove 22 of the centrifuge separation chamber 10 is located some distance above the top level of the static suspension liquid level, the particle suspension liquid (containing bacteria and debris) may only reach the upper levels of the first frustoconical chamber sidewall 12 and the sample groove 22 at the RCF-Apex during medium-to-high speed rotation. As rotational velocity increases, the liquid suspension is pulled to the walls of the first frustoconical chamber sidewall 12 and forms a “hollowed-core” column of liquid around the periphery of the center axis of the rotating centrifuge separation chamber 10. The thickness and height of this “column” of rotating bacterial suspension is directly proportional to the centrifuge separation chamber 10's inside shape (vertical angle of sidewalls), the chamber dimensions and the RCF created within the unit during rotation.

The sample groove 22 is preferably placed at a position of RCF or apex of the centrifuge separation chamber 10, allowing the maximum concentration of microbes and pathogens within the sample groove 22. In some cases liquid samples of up to 100 ml may be effectively reduced in sample volume to a 4 ml collection within the sample groove 22 in short time periods with a typical concentration of microbes 10 to 15 times that of normal sampling and concentration techniques. During continued rotation of the liquid column, suspended particles are pulled horizontally toward the first frustoconical chamber sidewall 12, and concurrently toward the point of maximum RCF (RCF-Apex) and corresponding sample groove 22 located near the top of the centrifuge separation chamber 10. During periods of relatively high rotational velocity, “clumped” bacteria and debris particles with attached microbes will be “packed” into the pellet within the small (preferably projected to be about 3 mm or less in diameter) sample groove 22, constructed around the inside circumference of the chamber at the RCF-Apex. The maximum centrifugal force at this point is projected to promote the movement of detached microbes around larger debris particles to the outer-most locations of the sample groove 22. After the liquid sample has been spun for a desired amount of time, the sample and centrifuge separation chamber 10 are then slowly decelerated until the centrifuge separation chamber 10 comes to rest. At that point, the sample or microbial pellet concentrated in the sample groove 22 may be removed from the centrifuge by manual or automated mechanisms including a pipette or vacuum suction device.

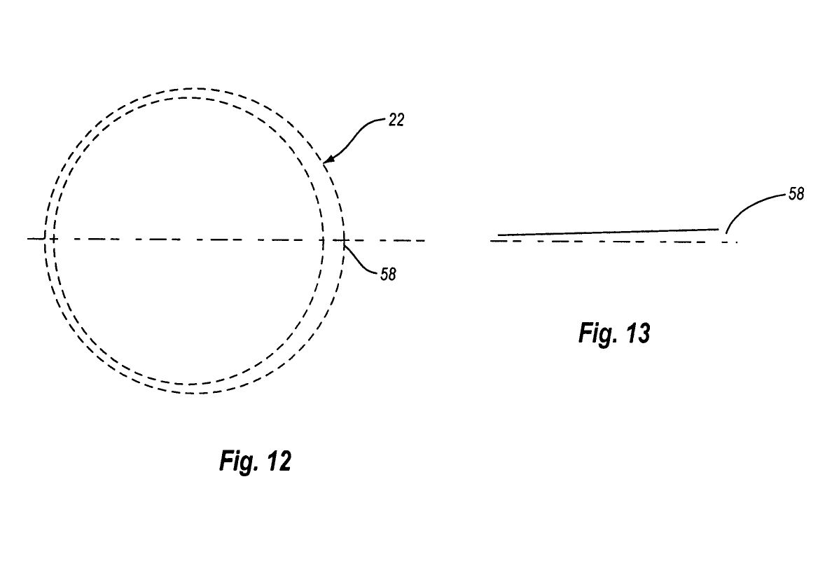

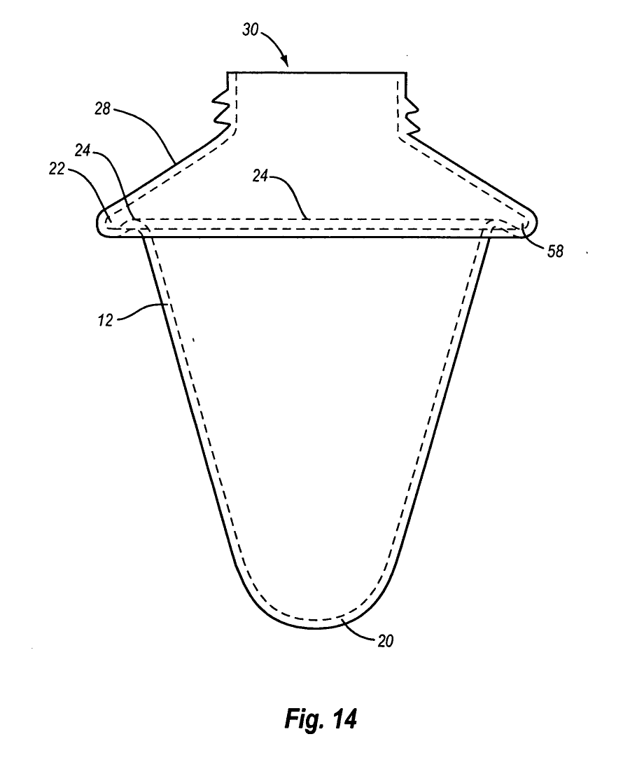

Although the sample groove and sample reservoir can be radial, another preferred embodiment includes a sample groove and sample reservoir with an angled portion that results in pooling of heavier particles in one place when centrifugation stops. FIG. 12 shows an example of the shape of a non-radial collection groove in which the RCF is highest at one point along the groove, the collection point 58. FIG. 12 is a top view showing only the shape of the sample groove, and FIG. 13 is a side view showing of such a chamber, with the floor of the sample groove sloping downward from point A to point B, with the collection point being located at point B. In such a design, with the sample groove sloping downward to a collection point 58, a pellet of particles would form in the collection point 58. FIG. 14 shows a side view of a separation chamber with a sample groove 22 sloping to a collection point 58. A sloping sample groove 22 and a collection point 58 could also be incorporated into the other chamber shapes, such as that shown in FIGS. 2, 4A, 4B, 4C and FIG. 11A.

As rotational velocity decreases at the end of the centrifuge process, or intermittently through the run as controlled by the user, the fraction of the swirling suspension liquid located above the sample groove 22 slowly moves down in response to the earth's gravitational pull. As the suspension liquid moves past the sample groove 22 and back into the lower portions of the first frustoconical chamber sidewall 12, the solution may effectively rinse excessive levels of debris away from the outermost portion or sample groove lip 24 of the sample groove 22. In some instances this will be desirable as larger particles will tend to collect at the sample groove lip 26 and will be effectively rinsed to the chamber base 20 as the deceleration process occurs. Although some loss of microbes is projected with this debris displacement, a significant level of concentrated microbes are expected to remain within the sample groove 22 for subsequent collection. Additionally, because the supernatant or solution of the sample generally drops below the level of the sample groove 22, the concentrated microbes are more easily accessed and sampled without first removing the liquid solution because of the position of the sample groove 22.

Aspiration of the concentrated microbial sample may occur through the central chamber opening 30 at the top of the centrifuge separation chamber 10 or through a rotating element that is connected to the centrifuge separation chamber 10 during or after rotation, allowing the sampling device to remove microbes, bacteria or other elements that have been effectively concentrated into the sample groove 22.

In an additional preferred embodiment, the centrifuge separation chamber 10 is of the same configuration as described above, except for a bottommost portion of the first frustoconical chamber sidewall 12. In this embodiment, the bottommost portion of the first frustoconical chamber sidewall 12 tapers outward in a second frustoconical chamber sidewall 14 and joins the first frustoconical chamber sidewall 12. In this embodiment, the centrifuge separation chamber 10 may initially be spun at an angle rather than vertically about the longitudinal axis of the chamber. As a result, the more dense particles within the liquid sample are spun into the bottommost corners of the centrifuge separation chamber 10. The centrifuge separation chamber 10 is then slowly decelerated until stopped and then positioned in a vertical centrifuge position. The sample is then again accelerated and rotated vertically about the longitudinal axis, allowing the more heavy and denser particles to remain at a bottommost portion of the centrifuge separation chamber 10 while still allowing the microbes and pathogens to spin upward into the sample groove 22. As a result, the samples removed from the sample groove 22 are more likely to be microbes and pathogens as desired by a user of the centrifuge separation chamber 10. While the microbial pellet is easily removed from the sample groove 22, the heavier and denser particles are still available for sampling from the debris zone 50 of the centrifuge separation chamber 10.

The centrifuge separation chamber 10 of the present invention is also extremely effective at lower speeds, allowing a more mobile and lightweight centrifuge process to be used for increased portability in field conditions. In an additional embodiment, the sample groove 22 will be positioned at a lower point on the first frustoconical chamber sidewall 12 allowing concentrations of microbes at lower angular velocities. The shape of the first frustoconical chamber sidewall 12 may also vary depending on the positioning of the sample groove 22. In some preferred embodiments, the centrifuge separation chamber 10 will include multiple sample grooves 22 positioned so that particles, sediment and microbes spun within the centrifuge separation chamber 10 are accumulated in different sample grooves 22 for facilitating the sampling process.

While there is shown and described the present preferred embodiment of the invention, it is to be distinctly understood that this invention is not limited thereto but may be variously embodied to practice within the scope of the following claims. From the foregoing description, it will be apparent that various changes may be made without departing from the spirit and scope of the invention as defined by the following claims.

1. A centrifuge separation chamber comprising:
a chamber base;
a first frustoconical chamber sidewall section, with a bottom edge and a top edge, with said bottom edge attached to said chamber base, with said sidewall smaller in diameter at the bottom edge than at said upper edge;
a sample groove at said upper edge of said chamber sidewall, for collection of heavier particles from a sample;
a chamber roof attached to said sample reservoir, said chamber roof tapering to a central chamber opening, through which sample can be introduced into said separation chamber or removed from said chamber; wherein
said centrifuge separation chamber is configured to spin in an axis parallel with the radial axis of the separation chamber, so that when spinning, heavier particles in said sample move toward said chamber sidewall, and are directed to and to collect in said sample groove, so that when spinning of said separation chamber stops, liquid in said sample moves toward the chamber base, and the heavier particles in said sample remain in said sample groove.

2. The centrifuge separation chamber of claim 1 in which said sample groove further comprises a sample groove lip, and a sample reservoir attached to said sample groove lip, with said sample reservoir positioned at a level lower than said lip.

3. The centrifuge separation chamber of claim 1 in which said sample groove is positioned at a point of peak relative centrifugal force, which is the point of the chamber wall which is furthest from the axis of rotation of the centrifuge.

4. The centrifuge separation chamber of claim 1 in which said axis of rotation is the same line as the radial axis of the centrifuge separation chamber.

5. The centrifuge separation chamber of claim 1 in which said axis or rotation is parallel to but different than the radial axis of the centrifuge separation chamber.

6. The centrifuge separation chamber of claim 5, which is configured for centrifugation using multiple separation chambers arranged radially around said axis of rotation.

7. The centrifuge separation chamber of claim 1, in which said base is convex shaped on the outside, and concave on the inside surface.

8. The centrifuge separation chamber of claim 1, in which said base is generally flat.

9. The centrifuge separation chamber of claim 1, in which said chamber base includes a drain orifice for removing liquid from said chamber.

10. The centrifuge separation chamber of claim 1 which further includes a second frustoconical sidewall section, with a sidewall taper opposite to that of the first frustoconical sidewall section, with the second frustoconical sidewall section having a top and bottom portion, with said bottom portion attached to said chamber base, tapering toward the radial axis and attached to the bottom edge of said first frustoconical sidewall section, which then tapers away from the radial axis toward the top of the chamber, with said second frustoconical sidewall section for concentration of larger particles of debris in said sample, and said first frustoconical sidewall section for collection of smaller suspended particles in said sample.

11. A centrifuge separation chamber comprising:
a chamber base;
a first frustoconical chamber sidewall section is a section of a frustocone and is attached to a number of generally straight sided sidewalls, with a bottom edge and a top edge, with said bottom edge attached to said chamber base, with said frustoconical sidewall tapering up from the bottom edge toward the upper edge;
a sample groove at said upper edge of said chamber sidewall, said sample groove comprising a sample groove lip, and a sample reservoir attached to said sample groove lip, with said sample reservoir positioned at a level lower than said sample groove lip;
a chamber roof attached to said sample reservoir, said chamber roof tapering to a central chamber opening, through which sample can be introduced into said separation chamber or removed from said chamber; wherein
said centrifuge separation chamber is configured to spin around an axis of rotation which is opposite to the first frustoconical sidewall, so that when spinning, heavier particles in said sample move toward said chamber sidewall, and collect in said sample reservoir, so that when spinning of said separation chamber stops, liquid in said sample moves toward the chamber base, and the heavier particles in said sample remain in said sample groove.

12. The centrifuge separation chamber of claim 11, which includes three generally flat walled sidewalls attached to said first frustoconical chamber sidewall.

13. The centrifuge separation chamber of claim 11, which includes two flat walled sidewalls attached to said first frustoconical chamber sidewall.

14. The centrifuge separation chamber of claim 11 which further includes a second frustoconical sidewall section, with a sidewall taper opposite to that of the first frustoconical sidewall section, with the second frustoconical sidewall section having a top and bottom portion, with said bottom portion attached to said chamber base, tapering toward the interior of the chamber, and attached to the bottom edge of said first frustoconical sidewall section, which then tapers away from the interior of the chamber, with said second frustoconical sidewall section for concentration of larger particles of debris in said sample, and said first frustoconical sidewall section for collection of smaller suspended particles in said sample.

15. A centrifuge separation chamber comprising:
a chamber base;
a first frustoconical chamber sidewall section is a section of a frustocone, and is attached to a number of generally straight sided sidewalls, with a bottom edge and a top edge, with said bottom edge attached to said chamber base, with said frustoconical sidewall tapering up from the bottom edge toward the upper edge;
a sample groove at said upper edge of said chamber sidewall, said sample groove comprising a sample groove lip, and a sample reservoir attached to said sample groove lip, with said sample reservoir positioned at a level lower than said sample groove lip;
a chamber roof attached to said sample reservoir, said chamber roof tapering to a central chamber opening, through which sample can be introduced into said separation chamber or removed from said chamber;
a second frustoconical sidewall section, with a sidewall taper opposite to that of the first frustoconical sidewall section, with the second frustoconical sidewall section having a top and bottom portion, with said bottom portion attached to said chamber base, tapering toward the interior of the chamber, and attached to the bottom edge of said first frustoconical sidewall section, which then tapers away from the interior of the chamber, with said second frustoconical sidewall section for concentration of larger particles of debris in said sample, and said first frustoconical sidewall section for collection of smaller suspended particles in said sample; wherein
said centrifuge separation chamber is configured to spin around an axis of rotation which is opposite to the first frustoconical sidewall, so that when spinning, heavier particles in said sample move toward said chamber sidewall, and collect in said sample reservoir, so that when spinning of said separation chamber stops, liquid in said sample moves toward the chamber base, and the heavier particles in said sample remain in said sample groove.

16. A centrifuge assembly comprising:
a plurality of centrifuge separation chambers arranged radially around an axis of rotation, with each centrifuge separation chamber comprising a first frustoconical chamber sidewall section which is a section of a frustocone, and is attached to a number of straight sided sidewalls, with a bottom edge and a top edge, with said bottom edge attached to said chamber base, with said sidewall tapering from said bottom edge toward said upper edge;
a sample groove at said upper edge of said chamber sidewall, said sample groove comprising a sample groove lip, and a sample reservoir attached to said sample groove lip, with said sample reservoir positioned at a level lower than said lip;
a chamber roof attached to said sample reservoir, said chamber roof tapering to a central chamber opening, through which sample can be introduced into said separation chamber or removed from said sample chamber; wherein
said centrifuge separation chamber is configured to spin around an axis of rotation which is opposite to the first frustoconical sidewall, so that when spinning, heavier particles in said sample to move toward said chamber sidewall, and collect in said sample reservoir, so that when spinning of said separation chamber stops, liquid in said sample moves toward the chamber base, and the heavier particles in said sample remain in said sample groove.

17. The centrifuge assembly of claim 16 in which each separation chamber further includes a second frustoconical sidewall section, with a sidewall taper opposite to that of the first frustoconical sidewall section, with the second frustoconical sidewall section having a top and bottom portion, with said bottom portion attached to said chamber base, tapering toward the interior of the chamber, and attached to the bottom edge of said first frustoconical sidewall section, which then tapers away from the interior of the chamber, with said second frustoconical sidewall section for concentration of larger particles of debris in said sample, and said first frustoconical sidewall section for collection of smaller suspended particles in said sample.

18. A sampling system comprising:
a centrifuge separation chamber, said separation chamber comprising:
a chamber base;
a first frustoconical chamber sidewall section, with a bottom edge and a top edge, with said bottom edge attached to said chamber base, with said sidewall smaller in diameter at the bottom edge than at said upper edge;
a sample groove at said upper edge of said chamber sidewall, said sample groove comprising a sample groove lip, and a sample reservoir attached to said sample groove lip, with said sample reservoir positioned at a level lower than said lip;
a chamber roof attached to said sample reservoir, said chamber roof tapering to a central chamber opening, through which sample can be introduced into or removed from said separation chamber; wherein said centrifuge separation chamber is configured to spin in an axis parallel with the radial axis of the separation chamber, and when spinning, for heavier particles in said sample to move toward said chamber sidewall, and to move toward the point of highest RCF, and be collected in said sample groove, so that when spinning of said separation chamber stops, liquid in said sample moves toward the chamber base, and the heavier particles in said sample remain in said sample groove;
a vacuum based sample collection unit, configured to pick up a liquid suspended sample and to deliver it into said centrifuge separation chamber.

19. A centrifuge separation chamber comprising:
an inverted cone shaped chamber for holding a liquid sample comprising an upper wider neck and a lower narrower neck;
a chamber base centrifuge separation chamber attached to said lower narrower neck of said inverted cone shaped chamber;
at least one sample groove extending substantially normal to said upper wider neck of said inverted cone shaped chamber at a point of peak relative centrifugal force; wherein
said centrifuge separation chamber is configured to spin in an axis parallel with the radial axis of the separation chamber, and when spinning, for heavier particles in said sample to move toward said chamber sidewall, and to be directed to and to collect in said sample reservoir, so that when spinning of said separation chamber stops, liquid in said sample moves toward the chamber base, and the heavier particles in said sample remain in said sample reservoir.

20. The centrifuge separation chamber of claim 19, further comprising a substantially flat bottom portion tapering outward from said inverted cone shaped chamber.

21. The centrifuge separation chamber of claim 19, wherein said collection groove includes a sample groove lip, and said collection groove extends 3 mm or less from an interconnection between said inverted cone shaped chamber and said collection groove lip.

22. The centrifuge separation chamber of claim 19, wherein said centrifuge separation chamber is disposable.

23. The centrifuge separation chamber of claim 19, wherein said centrifuge separation chamber may be used for any of collection, transportation and analysis.

24. The centrifuge separation chamber of claim 19, further comprising a plurality of collection grooves positioned at various levels of said inverted cone shaped chamber.

25. A high efficiency liquid microbial concentration system comprising:
a centrifugal separation chamber comprising;
tapered chamber walls comprising a narrow bottom portion and a wider upper portion;
a substantially flat bottom portion tapering extending outward from and sealing said narrow bottom portion of said tapered chamber walls;
a collection groove extending substantially radially around said wider upper portion of said tapered chamber walls at a point of peak relative centrifugal force;
a tapered cover narrowing inward from said collection groove; wherein
said centrifuge separation chamber is configured to spin in an axis parallel with the radial axis of the separation chamber, and when spinning, for heavier particles in said sample to move toward said chamber sidewall, and to be directed to and to collect in said sample reservoir, so that when spinning of said separation chamber stops, liquid in said sample moves toward the chamber base, and the heavier particles in said sample remain in said sample reservoir.
